(19) United States
(12) Patent Application Publication
(10) Pub. No.: US 2025/0150868 A1
(43) Pub. Date: May 8, 2025

(54) MOBILITY IN WIRELESS NETWORKS

(71) Applicant: Samsung Electronics Co., Ltd., Suwon-si (KR)

(72) Inventor: Shiyang Leng, Allen, TX (US)

(21) Appl. No.: 18/922,214

(22) Filed: Oct. 21, 2024

Related U.S. Application Data
(60) Provisional application No. 63/547,074, filed on Nov. 2, 2023.
(60) Provisional application No. 63/548,038, filed on Nov. 10, 2023.
(60) Provisional application No. 63/548,101, filed on Nov. 10, 2023.
(60) Provisional application No. 63/550,405, filed on Feb. 6, 2024.

(51) Int. Cl. H04W 24/08; H04L 5/00; H04W 36/00

(52) U.S. Cl. CPC H04W 24/08; H04L 5/0048; H04W 36/0061

(57) ABSTRACT

A distance event for an earth moving cell is introduced for event-triggered measurement report. The distance event is triggered when a first distance to a configured serving cell reference location is larger than a first threshold and a second distance to a configured neighbor cell reference location is smaller than a second threshold. A user equipment (UE) may determine a real-time reference location based on a reference time (epoch time), a reference location, and ephemeris information associated to a serving cell and neighbor cell. The ephemeris, the reference location, and the reference time for the serving cell are broadcast in SIB19. The ephemeris, the reference location, and the reference time for the neighbor cell are configured in the measurement object configuration.

### CROSS-REFERENCE TO RELATED APPLICATIONS

This application claims the benefit of priority from U.S. Provisional Application No. 63/547,074 entitled “MOBILITY IN WIRELESS NETWORKS WITH MULTI-BEAMS,” filed Nov. 2, 2023; U.S. Provisional Application No. 63/548,038 entitled “MOBILITY IN WIRELESS NETWORKS WITH MULTI-BEAMS,” filed Nov. 10, 2023; U.S. Provisional Application No. 63/548,101 entitled “MOBILITY IN WIRELESS NETWORKS WITH MULTI-BEAMS,” filed Nov. 10, 2023; and U.S. Provisional Application No. 63/550,405 entitled “MOBILITY IN WIRELESS NETWORKS WITH MULTI-BEAMS,” filed Feb. 6, 2024, all which are incorporated herein by reference in their entirety.

### TECHNICAL FIELD

This disclosure relates generally to a wireless communication system, and more particularly to, for example, but not limited to, mobility in a wireless communication system.

### BACKGROUND

Mobility management operations including network handovers represent a pivotal aspect of any wireless communication system. These systems include, for example, LTE and 5G New Radio (NR), and upcoming technologies currently coined “6G”. Mobility is presently controlled by the network with user equipment (UE) assistance to maintain optimal connection quality. The network may hand over the UE to a target cell with superior signal quality.

The inclusion of enhanced broadband mechanisms requiring high speeds and low latencies has necessitated more sophisticated handover mechanisms. Accordingly, conditional handovers (CHOs) and separately, layer 1/layer 2 triggered mobility (LTM) have been introduced to provide additional conditions for specific networks or slices thereof to increase handover speed. The use of these enhancements, however, introduces latencies of its own, at least because the network needs to conduct several data exchanges with the UE during the handover process. The initiation of a prospective handover triggered by the network consequently introduces latencies, signaling overhead, and interruption times of its own.

The description set forth in the background section should not be assumed to be prior art merely because it is set forth in the background section. The background section may describe aspects or embodiments of the present disclosure.

### SUMMARY

An aspect of the disclosure provides a user equipment (UE) for facilitating communication in a wireless network. The UE comprises a processor and a transceiver operably coupled to the processor. The processor is configured to determine whether an entering condition is satisfied. The entering condition is whether i) a first distance between the UE and a serving cell moving reference location is above a first threshold and ii) a second distance between the UE and a neighbor cell moving reference location is below a second threshold. The processor is configured to generate a measurement report based on a determination that the entering condition is satisfied. The transceiver is configured to transmit, to a serving cell, the measurement report.

In some embodiments, the processor is further configured to determine whether a leaving condition is satisfied, wherein the leaving condition is whether i) the first distance between the UE and the serving cell moving reference location is below the first threshold or ii) the second distance between the UE and the neighbor cell moving reference location is above the second threshold.

In some embodiments, the transceiver is further configured to receive, from the serving cell, a system information block that includes a first reference location, a first ephemeris information, and a first epoch time for the serving cell.

In some embodiments, the processor is further configured to determine the serving cell moving reference location based on the first reference location, the first ephemeris information, and the first epoch time.

In some embodiments, the transceiver is further configured to receive, from the serving cell, a measurement object configuration that includes a second reference location, a second ephemeris information, and a second epoch time for a neighbor cell

In some embodiments, the processor is further configured to determine the neighbor cell moving reference location based on the second reference location, the second ephemeris information, and the second epoch time.

In some embodiments, the processor is configured to determine that the entering condition is satisfied when a first entering condition and a second entering condition are fulfilled. The first entering condition:

$$Ml 1 - Hys > Thresh 1$$

where Ml1 is the first distance, Hys is a hysteresis parameter, and Thresh1 is the first threshold. The second entering condition:

$$Ml 2 + Hys < Thresh 2$$

where Ml2 is the second distance, Hys is the hysteresis parameter, and Thresh2 is the second threshold.

In some embodiments, the processor is configured to determine that the leaving condition is satisfied when at least one of a first leaving condition or a second leaving condition is fulfilled. The first leaving condition:

$$Ml 1 + Hys < Thresh 1$$

where Ml1 is the first distance, Hys is a hysteresis parameter, and Thresh1 is the first threshold. The second leaving condition:

$$Ml 2 - Hys > Thresh 2$$

where Ml2 is the second distance, Hys is the hysteresis parameter, and Thresh2 is the second threshold.

In some embodiments, the measurement object configuration is configured by the serving cell for the neighbor cell served by a non-terrestrial network earth moving cell.

In some embodiments, the transceiver is further configured to receive, from the serving cell, a configuration that indicates the first threshold and the second threshold.

An aspect of the disclosure provides a base station (BS) for facilitating communication in a wireless network. The BS comprises a processor and a transceiver operably coupled to the processor. The processor is configured to generate a configuration that triggers a measurement reporting event, the configuration indicating a first threshold and a second threshold that are associated with an entering condition for the measurement reporting event, wherein the entering condition is whether i) a first distance between a user equipment (UE) and a serving cell moving reference location is above the first threshold and ii) a second distance between the UE and a neighbor cell moving reference location is below the second threshold. The transceiver is configured to transmit, to the UE, the configuration.

In some embodiments, the first threshold and the second threshold are associated with a leaving condition for the measurement reporting event, and the leaving condition is whether i) the first distance between the UE and the serving cell moving reference location is below the first threshold and ii) the second distance between the UE and the neighbor cell moving reference location is above the second threshold.

In some embodiments, the processor is further configured to generate a system information block that includes a first reference location, a first ephemeris information, and a first epoch time for a serving cell associated with the base station.

In some embodiments, the transceiver is further configured to transmit, to the UE, the system information block. The serving cell moving reference location is determined based on the first reference location, the first ephemeris information, and the first epoch time.

In some embodiments, the processor is further configured to generate a measurement object configuration that includes a second reference location, a second ephemeris information, and a second epoch time for a neighbor cell

In some embodiments, the transceiver is further configured to transmit, to the UE, the measurement object configuration. The neighbor cell moving reference location is determined based on the second reference location, the second ephemeris information, and the second epoch time.

An aspect of the disclosure provides a method performed by a user equipment (UE) for facilitating communication in a wireless network. The method comprises determining whether an entering condition is satisfied, wherein the entering condition is whether i) a first distance between the UE and a serving cell moving reference location is above a first threshold and ii) a second distance between the UE and a neighbor cell moving reference location is below a second threshold. The method comprises generating a measurement report based on a determination that the entering condition is satisfied. The method comprises transmitting, to a serving cell, the measurement report.

In some embodiments, the method further comprises determining whether a leaving condition is satisfied, wherein the leaving condition is whether i) the first distance between the UE and the serving cell moving reference location is below the first threshold or ii) the second distance between the UE and the neighbor cell moving reference location is above the second threshold.

In some embodiments, the method further comprises receiving, from the serving cell, a system information block that includes a first reference location, a first ephemeris information, and a first epoch time for the serving cell. The method further comprises determining the serving cell moving reference location based on the first reference location, the first ephemeris information, and the first epoch time.

In some embodiments, the method further comprises receiving, from the serving cell, a measurement object configuration that includes a second reference location, a second ephemeris information, and a second epoch time for a neighbor cell. The method further comprises determining the neighbor cell moving reference location based on the second reference location, the second ephemeris information, and the second epoch time.

In some embodiments, the entering condition is satisfied when a first entering condition and a second entering condition are fulfilled. The first entering condition:

$$Ml 1 - Hys > Thresh 1$$

where Ml1 is the first distance, Hys is a hysteresis parameter, and Thresh1 is the first threshold. The second entering condition:

$$M l 2 + Hys < Thresh 2$$

where Ml2 is the second distance, Hys is the hysteresis parameter, and Thresh2 is the second threshold.

In some embodiments, the leaving condition is satisfied when at least one of a first leaving condition or a second leaving condition is fulfilled. The first leaving condition:

$$Ml 1 + Hys < Thresh 1$$

where Ml1 is the first distance, Hys is a hysteresis parameter, and Thresh1 is the first threshold. The second leaving condition:

$$Ml 2 - Hys > Thresh 2$$

where Ml2 is the second distance, Hys is the hysteresis parameter, and Thresh2 is the second threshold.

In some embodiments, the measurement object configuration is configured by the serving cell for the neighbor cell served by a non-terrestrial network earth moving cell.

In some embodiments, the method further comprises receiving, from the serving cell, a configuration that indicates the first threshold and the second threshold.

### BRIEF DESCRIPTION OF THE DRAWINGS

FIG. 1 shows an example of a wireless network in accordance with an embodiment.

FIG. 2A shows an example of a wireless transmit path in accordance with an embodiment.

FIG. 2B shows an example of a wireless receive path in accordance with an embodiment.

FIG. 3A shows an example of a user equipment (“UE”) in accordance with an embodiment.

FIG. 3B shows an example of a base station (“BS”) in accordance with an embodiment.

FIG. 4 shows an example process 400 for measurement reporting in accordance with an embodiment.

In one or more implementations, not all the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in numerous ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied using a multitude of different approaches. The examples in this disclosure are based on the current 5G NR systems, 5G-Advanced (5G-A) and further improvements and advancements thereof and to the upcoming 6G communication systems. However, under various circumstances, the described embodiments may also be implemented in any device, system or network that is capable of transmitting and receiving radio frequency (RF) signals according to other technologies, such as the 3G and 4G systems, or further implementations thereof. For example, the principles of the disclosure may apply to Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), enhancements of 5G NR, AMPS, or other known signals that are used to communicate within a wireless, cellular or IoT network, such as one or more of the above-described systems utilizing 3G, 4G, 5G, 6G or further implementations thereof. The technology may also be relevant to and may apply to any of the existing or proposed IEEE 802.11 standards, the Bluetooth standard, and other wireless communication standards.

Wireless communications like the ones described above have been among the most commercially acceptable innovations in history. Setting aside the automated software, robotics, machine learning techniques, and other software that automatically use these types of communication devices, the sheer number of wireless or cellular subscribers continues to grow. A little over a year ago, the number of subscribers to the various types of communication services had exceeded five billion. That number has long since been surpassed and continues to grow quickly. The demand for services employing wireless data traffic is also rapidly increasing, in part due to the growing popularity among consumers and businesses of smart phones and other mobile data devices, such as tablets, “note pad” computers, net books, eBook readers, and dedicated machine-type devices. It should be self-evident that, to meet the high growth in mobile data traffic and support new applications and deployments, improvements in radio interface efficiency and coverage are of paramount importance.

To continue to accommodate the growing demand for the transmission of wireless data traffic having dramatically increased over the years, and to facilitate the growth and sophistication of so-called “vertical applications” (that is, code written or produced in accordance with a user's or entities' specific requirements to achieve objectives unique to that user or entity, including enterprise resource planning and customer relationship management software, for example), 5G communication systems have been developed and are currently being deployed commercially. 5G Advanced, as defined in 3GPP Release 18, is yet a further upgrade to aspects of 5G and has already been introduced as an optimization to 5G in certain countries. Development of 5G Advanced is well underway. The development and enhancements of 5G also can accord processing resources greater overall efficiency, including, by way of example, in high-intensive machine learning environments involving precision medical instruments, measurement devices, robotics, and the like. Due to 5G and its expected successor technologies, access to one or more application programming interfaces (APIs) and other software routines by these devices are expected to be more robust and to operate at faster speeds.

Among other advantages, 5G can be implemented to include higher frequency bands, including in particular 28 GHz or 60 GHz frequency bands. More generally, such frequency bands may include those above 6 GHz bands. A key benefit of these higher frequency bands are potentially significantly superior data rates. One drawback is the requirement in some cases of line-of-sight (LOS), the difficulty of higher frequencies to penetrate barriers between the base station and UE, and the shorter overall transmission range. 5G systems rely on more directed communications (e.g., using multiple antennas, massive multiple-input multiple-output (MIMO) implementations, transmit and/or receive beamforming, temporary power increases, and like measures) when transmitting at these mmWave (mmW) frequencies. In addition, 5G can beneficially be transmitted using lower frequency bands, such as below 6 GHz, to enable more robust and distant coverage and for mobility support (including handoffs and the like). As noted above, various aspects of the present disclosure may be applied to 5G deployments, to 6G systems currently under development, and to subsequent releases. The latter category may include those standards that apply to the THz frequency bands. To decrease propagation loss of the radio waves and increase transmission distance. as noted in part, emerging technologies like MIMO, Full Dimensional MIMO (FD-MIMO), array antenna, digital and analog beamforming, large scale antenna techniques and other technologies are discussed in the various 3GPP-based standards that define the implementation of 5G communication systems.

In addition, in 5G communication systems, development for system network improvement is underway or has been deployed based on advanced small cells, cloud Radio Access Networks (RANs), ultra-dense networks, device-to-device (D2D) communication, wireless backhaul, moving networks, cooperative communication, Coordinated Multi-Points (CoMP), reception-end interference cancellation, and the like. As exemplary technologies like neural-network machine learning, unmanned or partially-controlled electric vehicles, or hydrogen-based vehicles begin to emerge, these 5G advances are expected to play a potentially significant role in their respective implementations. Further advanced access technologies under the umbrella of 5G that have been developed or that are under development include, for example: advanced coding modulation (ACM) schemes using Hybrid frequency-shift-keying (FSK), frequency quadrature amplitude modulation (FQAM) and sliding window superposition coding (SWSC); and advanced access technologies using filter bank multi-carrier (FBMC), non-orthogonal multiple access (NOMA), and sparse code multiple access (SCMA).

Also under development are the principles of the 6G technology, which may roll out commercially at the end of decade or even earlier. 6G systems are expected to take most or all the improvements brought by 5G and improve them further, as well as to add new features and capabilities. It is also anticipated that 6G will tap into uncharted areas of bandwidth to increase overall capacities. As noted, principles of this disclosure are expected to apply with equal force to 6G systems, and beyond.

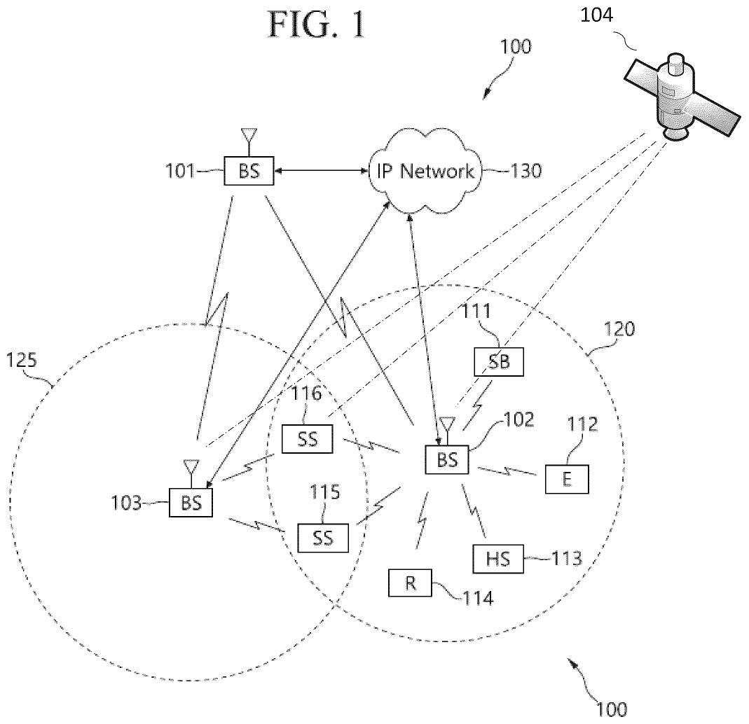

FIG. 1 shows an example of a wireless network 100 in accordance with an embodiment. The embodiment of the wireless network 100 shown in FIG. 1 is for purposes of illustration only. Other embodiments of the wireless network 100 can be used without departing from the scope of this disclosure. Initially it should be noted that the nomenclature may vary widely depending on the system. For example, in FIG. 1, the terminology “BS” (base station) may also be referred to as an eNodeB (eNB), a gNodeB (gNB), or at the time of commercial release of 6G, the BS may have another name. For the purposes of this disclosure, BS and gNB are used interchangeably. Thus, depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Referring back to FIG. 1, the network 100 includes BSs (or gNBs) 101, 102, and 103. BS 101 communicates with BS 102 and BS 103. BSs may be connected by way of a known backhaul connection, or another connection method, such as a wireless connection. BS 101 also communicates with at least one Internet Protocol (IP)-based network 130. Network 130 may include the Internet, a proprietary IP network, or another network.

Similarly, depending on the network 100 type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used interchangeably with “subscriber station” in this patent document to refer to remote wireless equipment that wirelessly accesses a gNB, whether the UE is a mobile device (such as a mobile telephone or smartphone) or is normally considered a stationary device (such as a desktop computer, vending machine, appliance, or any device with wireless connectivity compatible with network 100). With continued reference to FIG. 1, BS 102 provides wireless broadband access to the IP network 130 for a first plurality of user equipments (UEs) within a coverage area 120 of the BS 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The BS 103 provides wireless broadband access to IP network 130 for a second plurality of UEs within a coverage area 125 of the BS 103. The second plurality of UEs includes the UE 115 and the UE 116, which are in both coverage areas 120 and 125. In some embodiments, one or more of the BSs 101-103 may communicate with each other and with the UEs 111-116 using 6G, 5G, long-term evolution (LTE), LTE-A, WiMAX, or other advanced wireless communication techniques.

In FIG. 1, as noted, dotted lines show the approximate extents of the coverage area 120 and 125 of BSs 102 and 103, respectively, which are shown as approximately circular for the purposes of illustration and explanation. It should be clearly understood that coverage areas associated with BSs, such as the coverage areas 120 and 125, may have other shapes, including irregular shapes, depending on the configuration of the BSs. Although FIG. 1 illustrates one example of a wireless network 100, various changes may be made to FIG. 1. For example, the wireless network 100 can include any number of BSs/gNBs and any number of UEs in any suitable arrangement. Also, the BS 101 can communicate directly with any number of UEs and provide those UEs with wireless broadband access to IP network 130. Similarly, each BS 102 or 103 can communicate directly with IP network 130 and provide UEs with direct wireless broadband access to the network 130. Further, gNB 101, 102, and/or 103 can provide access to other or additional external networks, such as external telephone networks or other types of data networks.

As discussed in greater detail below, the wireless network 100 may have communications facilitated via one or more communication satellite(s) 104 that may be in orbit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to traditional fronthaul and/or backhaul connections. The BSs 102 and 103 can also be on board the communication satellite(s) 104. One or more of the UEs (e.g., as depicted by UE 116) may be capable of at least some direct communication and/or localization with the communication satellite(s) 104.

A non-terrestrial network (NTN) refers to a network, or segment of networks using RF resources on board a communication satellite (or unmanned aircraft system platform) (e.g., communication satellite(s) 104). Considering the capabilities of providing wide coverage and reliable service, an NTN is envisioned to ensure service availability and continuity ubiquitously. For instance, an NTN can support communication services in unserved areas that cannot be covered by conventional terrestrial networks, in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof for supporting mobility in wireless networks. In certain embodiments, one or more of the BSs 101-103 include circuitry, programing, or a combination thereof to mobility in wireless networks.

It will be appreciated that in 5G systems, the BS 101 may include multiple antennas, multiple radio frequency (RF) transceivers, transmit (TX) processing circuitry, and receive (RX) processing circuitry. The BS 101 also may include a controller/processor, a memory, and a backhaul or network interface. The RF transceivers may receive, from the antennas, incoming RF signals, such as signals transmitted by UEs in network 100. The RF transceivers may down-convert the incoming RF signals to generate intermediate (IF) or baseband signals. The IF or baseband signals are sent to the RX processing circuitry, which generates processed baseband signals by filtering, decoding, and/or digitizing the baseband or IF signals. The RX processing circuitry transmits the processed baseband signals to the controller/processor for further processing.

The controller/processor can include one or more processors or other processing devices that control the overall operation of the BS 101 (FIG. 1). For example, the controller/processor may control the reception of uplink signals and the transmission of downlink signals by the UEs, the RX processing circuitry, and the TX processing circuitry in accordance with well-known principles. The controller/processor may support additional functions as well, such as more advanced wireless communication functions. For instance, the controller/processor may support beamforming or directional routing operations in which outgoing signals from multiple antennas are weighted differently to effectively steer the outgoing signals in a desired direction. The controller/processor may also support OFDMA operations in which outgoing signals may be assigned to different subsets of subcarriers for different recipients (e.g., different UEs 111-114). Any of a wide variety of other functions may be supported in the BS 101 by the controller/processor including a combination of MIMO and OFDMA in the same transmit opportunity. In some embodiments, the controller/processor may include at least one microprocessor or microcontroller. The controller/processor is also capable of executing programs and other processes resident in the memory, such as an OS. The controller/processor can move data into or out of the memory as required by an executing process.

The controller/processor is also coupled to the backhaul or network interface. The backhaul or network interface allows the BS 101 to communicate with other BSs, devices or systems over a backhaul connection or over a network. The interface may support communications over any suitable wired or wireless connection(s). For example, the interface may allow the BS 101 to communicate over a wired or wireless local area network or over a wired or wireless connection to a larger network (such as the Internet). The interface may include any suitable structure supporting communications over a wired or wireless connection, such as an Ethernet or RF transceiver. The memory is coupled to the controller/processor. Part of the memory may include a RAM, and another part of the memory may include a Flash memory or other ROM.

For purposes of this disclosure, the processor may encompass not only the main processor, but also other hardware, firmware, middleware, or software implementations that may be responsible for performing the various functions. In addition, the processor's execution of code in a memory may include multiple processors and other elements and may include one or more physical memories. Thus, for example, the executable code or the data may be located in different physical memories, which embodiment remains within the spirit and scope of the present disclosure.

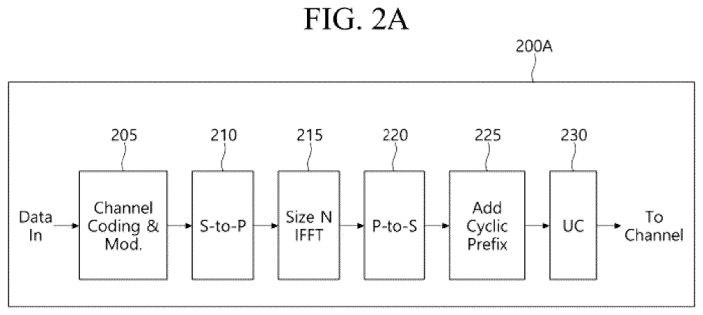

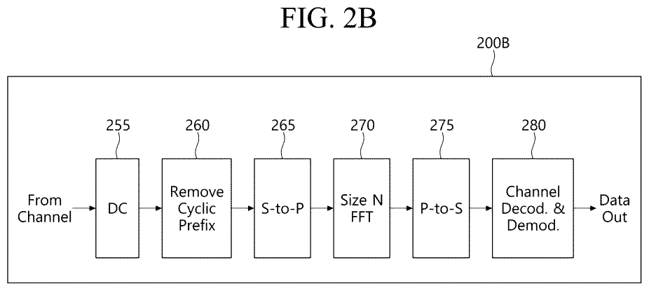

FIG. 2A shows an example of a wireless transmit path 200A in accordance with an embodiment. FIG. 2B shows an example of a wireless receive path 200B in accordance with an embodiment. In the following description, a transmit path 200A may be implemented in a gNB/BS (such as BS 102 of FIG. 1), while a receive path 200B may be implemented in a UE (such as UE 111 (SB) of FIG. 1). However, it will be understood that the receive path 200B can be implemented in a BS and that the transmit path 200A can be implemented in a UE. In some embodiments, the receive path 200B is configured to support the codebook design and structure for systems having 2D antenna arrays as described in some embodiments of the present disclosure. That is to say, each of the BS and the UE include transmit and receive paths such that duplex communication (such as a voice conversation) is made possible. In some embodiments, the transmit path 200A and the receive path 200B is configured to support mobility in wireless networks as described in various embodiments of the present disclosure.

The transmit path 200A includes a channel coding and modulation block 205 for modulating and encoding the data bits into symbols, a serial-to-parallel (S-to-P) conversion block 210, a size N Inverse Fast Fourier Transform (IFFT) block 215 for converting N frequency-based signals back to the time domain before they are transmitted, a parallel-to-serial (P-to-S) block 220 for serializing the parallel data block from the IFFT block 215 into a single datastream (noting that BSs/UEs with multiple transmit paths may each transmit a separate datastream), an add cyclic prefix block 225 for appending a guard interval that may be a replica of the end part of the orthogonal frequency domain modulation (OFDM) symbol (or whatever modulation scheme is used) and is generally at least as long as the delay spread to mitigate effects of multipath propagation. Alternatively, the cyclic prefix may contain data about a corresponding frame or other unit of data. An up-converter (UC) 230 is next used for modulating the baseband (or in some cases, the intermediate frequency (IF)) signal onto the carrier signal to be used as an RF signal for transmission across an antenna.

The receive path 200B essentially includes the opposite circuitry and includes a down-converter (DC) 255 for removing the datastream from the carrier signal and restoring it to a baseband (or in other embodiments an IF) datastream, a remove cyclic prefix block 260 for removing the guard interval (or removing the interval of a different length), a serial-to-parallel (S-to-P) block 265 for taking the datastream and parallelizing it into N datastreams for faster operations, a multi-input size N Fast Fourier Transform (FFT) block 270 for converting the N time-domain signals to symbols into the frequency domain, a parallel-to-serial (P-to-S) block 275 for serializing the symbols, and a channel decoding and demodulation block 280 for decoding the data and demodulating the symbols into bits using whatever demodulating and decoding scheme was used to initially modulate and encode the data in reference to the transmit path 200A.

As a further example, in the transmit path 200A of FIG. 2A, the channel coding and modulation block 205 receives a set of information bits, applies coding (such as a low-density parity check (LDPC) coding), and modulates the input bits (such as with Quadrature Phase Shift Keying (QPSK), Quadrature Amplitude Modulation (QAM), Orthogonal Frequency Domain Multiple Access (OFDMA), or other current or future modulation schemes) to generate a sequence of frequency-domain modulation symbols. The serial-to-parallel block 210 converts (such as de-multiplexes) the serial modulated symbols to parallel data to generate N parallel symbol streams, where as noted, N is the IFFT/FFT size used in the BS 102 and the UE 116 FIG. 1). The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 to generate a serial time-domain signal. The add cyclic prefix block 225 inserts a cyclic prefix to the time-domain signal. The up-converter 230 modulates (such as up-converts) the output of the add cyclic prefix block 225 from baseband (or in other embodiments, an intermediate frequency IF) to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116 (FIG. 1). The down-converter 255 (for example, at UE 116) down-converts the received signal to a baseband or IF frequency, and the remove cyclic prefix block 260 removes the cyclic prefix to generate a serial time-domain baseband signal. The serial-to-parallel block 265 converts or multiplexes the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream. The data stream may then be portioned and processed accordingly using a processor and its associated memory(ies). Each of the BSs 101-103 of FIG. 1 may implement a transmit path 200A that is analogous to transmitting in the downlink to UEs 111-116, Likewise, each of the BSs 101-103 may implement a receive path 200B that is analogous to receiving in the uplink from UEs 111-116. Similarly, to realize bidirectional signal execution, each of UEs 111-116 may implement a transmit path 200A for transmitting in the uplink to BSs 101-103 and each of UEs 111-116 may implement a receive path 200B for receiving in the downlink from gNBs 101-103. In this manner, a given UE may exchange signals bidirectionally with a BS within its range, and vice versa.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation. In addition, although described as using FFT and IFFT, this exemplary implementation is by way of illustration only and should not be construed to limit the scope of this disclosure. For example, other types of transforms, such as Discrete Fourier Transform (DFT) and Inverse Discrete Fourier Transform (IDFT) functions, can be used in lieu of the FFT/IFFT. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions. Additionally, although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network. For example, the functions performed by the modules in FIGS. 2A and 2B may be performed by a processor executing the correct code in memory corresponding to each module.

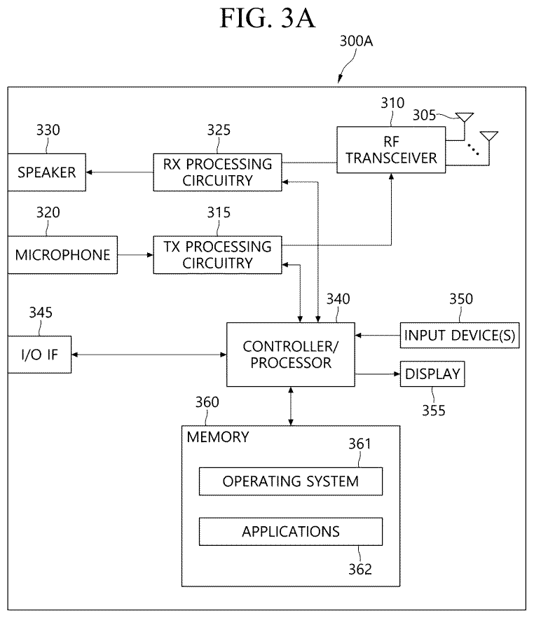

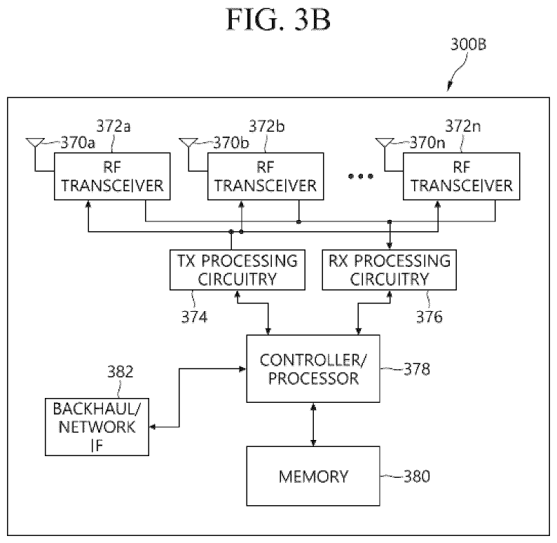

FIG. 3A shows an example of a user equipment (“UE”) 300A (which may be UE 116 in FIG. 1, for example, or another UE) in accordance with an embodiment. It should be underscored that the embodiment of the UE 300A illustrated in FIG. 3A is for illustrative purposes only, and the UEs 111-116 of FIG. 1 can have the same or similar configuration. However, UEs come in a wide variety of configurations, and the UE 300A of FIG. 3A does not limit the scope of this disclosure to any particular implementation of a UE. Referring now to the components of FIG. 3A, the UE 300A includes an antenna 305 (which may be a single antenna or an array or plurality thereof in other UEs), a radio frequency (RF) transceiver 310, transmit (TX) processing circuitry 315 coupled to the RF transceiver 310, a microphone 320, and receive (RX) processing circuitry 325. The UE 300A also includes a speaker 330 coupled to the receive processing circuitry 325, a main processor 340, an input/output (I/O) interface (IF) 345 coupled to the processor 340, a keypad (or other input device(s)) 350, a display 355, and a memory 360 coupled to the processor 340. The memory 360 includes a basic operating system (OS) program 361 and one or more applications 362, in addition to data. In some embodiments, the display 355 may also constitute an input touchpad and in that case, it may be bidirectionally coupled with the processor 340.

The RF transceiver may include more than one transceiver, depending on the sophistication and configuration of the UE. The RF transceiver 310 receives from antenna 305, an incoming RF signal transmitted by a BS of the network 100. The RF transceiver sends and receives wireless data and control information. The RF transceiver is operable coupled to the processor 340, in this example via TX processing circuitry 315 and RF processing circuitry 325. The RF transceiver 310 may thereupon down-convert the incoming RF signal to generate an intermediate frequency (IF) or baseband signal. In some embodiments, the down-conversion may be performed by another device coupled to the transceiver. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as in the context of a voice call) or to the main processor 340 for further processing (such as for web browsing data or any number of other applications). The TX processing circuitry 315 receives analog or digital voice data from the microphone 320 or, in other cases, TX processing circuitry 315 may receive other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305. The same operations may be performed using alternative methods and arrangements without departing from the spirit or scope of the present disclosure.

The main processor 340 can include one or more processors or other processing devices and execute the basic OS program 361 stored in the memory 360 to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller. The transceiver 310 coupled to the processor 340, directly or through intervening elements. The main processor 340 is also capable of executing other processes and programs resident in the memory 360, such as CLTM in wireless communication systems as described in embodiments of the present disclosure. The main processor 340 can move data into or out of the memory 360 as required by an executing process. In some embodiments, the main processor 340 is configured to execute the applications 362 based on the OS program 361 or in response to signals received from BSs or an operator of the UE. For example, the main processor 340 may execute processes to support mobility in wireless networks as described in various embodiments of the present disclosure. The main processor 340 is also coupled to the I/O interface 345, which provides the UE 300A with the ability to connect to other devices such as laptop computers and handheld computers. The I/O interface 345 is the communication path between these accessories and the main controller 340. The main processor 340 is also coupled to the keypad 350 and the display unit 355. The operator of the UE 300A can use the keypad 350 to enter data into the UE 300A. The display 355 may be a liquid crystal display or other display capable of rendering text and/or at least limited graphics, such as from web sites. The memory 360 is coupled to the main processor 340. Part of the memory 360 can include a random-access memory (RAM), and another part of the memory 360 can include a Flash memory or other read-only memory (ROM).

The UE 300A of FIG. 3A may also include additional or different types of memory, including dynamic random-access memory (DRAM), non-volatile flash memory, static RAM (SRAM), different levels of cache memory, etc. While the main processor 340 may be a complex-instruction set computer (CISC)-based processor with one or multiple cores, it was noted that in other embodiments, the processor may include a plurality of processors. The processor(s) may also include a reduced instruction set computer (RISC)-based processor. The various other components of UE 300A may include separate processors, or they may be controlled in part or in full by firmware or middleware. For example, any one or more of the components of UE 300A may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the UE 300A may rely on middleware or firmware, updates of which may be received from time to time. For smartphones and other UEs whose objective is typically to be compact, the hardware design may be implemented to reflect this smaller aspect ratio. The antenna(s) may stick out of the device, or in other UEs, the antenna(s) may be implanted in the UE body. The display panel may include a layer of indium tin oxide or a similar compound to enable the display to act as a touchpad. In short, although FIG. 3A illustrates one example of UE 300A, various changes may be made to FIG. 3A without departing from the scope of the disclosure. For example, various components in FIG. 3A can be combined, further subdivided, or omitted and additional components can be added according to particular needs. As one example noted above, the main processor 340 can be divided into multiple processors, such as one or more central processing units (CPUs) and one or more graphics processing units (GPUS). Also, while FIG. 3A may include a UE (e.g., UE 116 in FIG. 1) configured as a mobile telephone or smartphone, UEs can be configured to operate as other types of mobile or stationary devices. For example, UEs may be incorporated in tower desktop computers, tablet computers, notebooks, workstations, and servers.

FIG. 3B shows an example of a BS 300B in accordance with an embodiment. A non-exhaustive example of a BS 300B may be that of BS 102 in FIG. 1. As noted, the terminology BS and gNB may be used interchangeably for purposes of this disclosure. The embodiment of the BS 300B shown in FIG. 3B is for illustration only, and other BSs of FIG. 1 can have the same or similar configuration. However, BSs/gNBs come in a wide variety of configurations, and it should be emphasized that the BS shown in FIG. 3B does not limit the scope of this disclosure to any particular implementation of a BS. For example, BS 101 and BS 103 can include the same or similar structure as BS 102 in FIG. 1 or BS 300B (FIG. 3B), or they may have different structures. As shown in FIG. 3B, the BS 300B includes multiple antennas 370a-370n, multiple corresponding RF transceivers 372a-372n, transmit (TX) processing circuitry 374, and receive (RX) processing circuitry 376. The transceivers 372a-372N are coupled to a processor, directly or through intervening elements. In certain embodiments, one or more of the multiple antennas 370a-370n include 2D antenna arrays. The BS 300B also includes a controller/processor 378 (hereinafter “processor 378”), a memory 380, and a backhaul or network interface 382. The RF transceivers 372a-372n receive, from the antennas 370a-370n, incoming RF signals, such as signals transmitted by UEs or other BSs. The RF transceivers 372a-372n down-convert the incoming respective RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing. The TX processing circuitry 374 receives analog or digital data (such as voice data, web data, e-mail, interactive video game data, or data used in a machine learning program, etc.) from the processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-convert the baseband or IF signals to RF signals that are transmitted via the antennas 370a-370n. It should be noted that the above is descriptive in nature; in actuality not all antennas 370-370n need be simultaneously active.

The processor 378 can include one or more processors or other processing devices that control the overall operation of the BS 300B. For example, the processor 378 can control the reception of forward channel signals and the transmission of reverse channel signals by the RF transceivers 372a-372n, the RX processing circuitry 376, and the TX processing circuitry 374 in accordance with well-known principles. As another example, the processor 378 could support mobility in wireless networks. The processor 378 can support additional functions as well, such as more advanced wireless communication functions. For instance, the processor 378 can perform the blind interference sensing (BIS) process, such as performed by a BIS algorithm, and decode the received signal subtracted by the interfering signals. Any of a wide variety of other functions can be supported in the BS 300B by the processor 378. In some embodiments, the processor 378 includes at least one microprocessor or microcontroller, or an array thereof. The processor 378 is also capable of executing programs and other processes resident in the memory 380, such as a basic operating system (OS). The processor 378 is also capable of supporting CLTM in wireless communication systems as described in embodiments of the present disclosure. In some embodiments, the controller/processor 378 supports communications between entities, such as web RTC. The processor 378 can move data into or out of the memory 380 as required by an executing process. A backhaul or network interface 382 allows the BS 300B to communicate with other devices or systems over a backhaul connection or over a network. The interface 382 can support communications over any suitable wired or wireless connection(s). For example, when the BS 300B is implemented as part of a cellular communication system (such as one supporting 5G, 5G-A, LTE, or LTE-A, etc.), the interface 382 can allow the BS 102 (FIG. 1) to communicate with other BSs over a wired or wireless backhaul connection. Referring back to FIG. 3B, the interface 382 can allow the BS 102 to communicate over a wired or wireless local area network or over a wired or wireless connection to a larger network (such as the Internet). The interface 382 includes any suitable structure supporting communications over a wired or wireless connection, such as an Ethernet or RF transceiver. The memory 380 is coupled to the processor 378. Part of the memory 380 can include a RAM, and another part of the memory 380 can include a Flash memory or other ROM. In certain exemplary embodiments, a plurality of instructions, such as a Bispectral Index Algorithm (BIS) may be stored in memory. The plurality of instructions are configured to cause the processor 378 to perform the BIS process and to decode a received signal after subtracting out at least one interfering signal determined by the BIS algorithm.

As described in more detail below, the transmit and receive paths of the BS 102 (implemented in the example of FIG. 3B as BS 300B using the RF transceivers 372a-372n, TX processing circuitry 374, and/or RX processing circuitry 376) support communication with aggregation of frequency division duplex (FDD) cells or time division duplex (TDD) cells, or some combination of both. That is, communications with a plurality of UEs can be accomplished by assigning an uplink of transceiver to a certain frequency and establishing the downlink using a different frequency (FDD). In TDD, the uplink and downlink divisions are accomplished by allotting certain times for uplink transmission to the BS and other times for downlink transmission from the BS to a UE. Although FIG. 3B illustrates one example of a BS 300B which may be similar or equivalent to BS 102 (FIG. 1), various changes may be made to FIG. 3B. For example, the BS 300B can include any number of each component shown in FIG. 3B. As a particular example, an access point can include multiple interfaces 382, and the processor 378 can support routing functions to route data between different network addresses. As another example, while described relative to FIG. 3B for simplicity as including a single instance of TX processing circuitry 374 and a single instance of RX processing circuitry 376, the BS 300B can include multiple instances of each (such as one transmission or receive per RF transceiver).

As an example, Release 13 of the LTE standard supports up to 16 CSI-RS [channel status information-reference signal] antenna ports which enable a BS to be equipped with a large number of antenna elements (such as 64 or 128). In this case, a plurality of antenna elements is mapped onto one CSI-RS port. Furthermore, up to 32 CSI-RS ports are supported in Rel. 14 LTE. For next generation cellular systems such as 5G, the maximum number of CSI-RS ports may be greater. The CSI-RS is a type of reference signal transmitted by the BS to the UE to allow the UE to estimate the downlink radio channel quality. The CSI-RS can be transmitted in any available OFDM symbols and subcarriers as configured in the radio resource control (RRC) message. The UE measures various radio channel qualities (time delay, signal-to-noise ratio, power, etc.) and reports the results to the BS.

The BS 300B of FIG. 3B may also include additional or different types of memory 380, including dynamic random-access memory (DRAM), non-volatile flash memory, static RAM (SRAM), different levels of cache memory, etc. While the main processor 378 may be a complex-instruction set computer (CISC)-based processor with one or multiple cores, in other embodiments, the processor may include a plurality or an array of processors. Often in embodiments, the processing power and requirements of the BS may be much higher than that of the typical UE, although this is not required. Some BSs may include a large structure on a tower or other structure, and their immobility accords them access to fixed power without the need for any local power except backup batteries in a blackout-type event. The processor(s) 378 may also include a reduced instruction set computer (RISC)-based processor or an array thereof. The various other components of BS 300B may include separate processors, or they may be controlled in part or in full by firmware or middleware. For example, any one or more of the components of BS 300B may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the BS 300B may rely on middleware or firmware, updates of which may be received from time to time. In some configurations, the BS may include layers of stacked motherboards to accommodate larger processing needs, and to process channel state information (CSI) and other data received from the UEs in the vicinity.

In short, although FIG. 3B illustrates one example of a BS, various changes may be made to FIG. 3B without departing from the scope of the disclosure. For example, various components in FIG. 3B can be combined, further subdivided, or omitted, and additional components can be added according to particular needs. As one example noted above, the main processor 378 can be divided into multiple processors, such as one or more central processing units (CPUs) and one or more graphics processing units (GPUs)—or in some cases, multiple motherboards for enhanced functionality. The BS may also include substantial solid-state drive (SSD) memory, or magnetic hard disks to retain data for prolonged periods. Also, while one example of BS 300B was that of a structure on a tower, this depiction is exemplary only, and the BS may be present in other forms in accordance with well-known principles.

A description of various aspects of the disclosure is provided below. The text in the written description and corresponding figures are provided solely as examples to aid the reader in understanding the principles of the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

Aspects, features, and advantages of the disclosure are readily apparent from the following detailed description. Several embodiments and implementations are shown for illustrative purposes. The disclosure is also capable of further and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

Although exemplary descriptions and embodiments to follow employ orthogonal frequency division multiplexing (OFDM) or orthogonal frequency division multiple access (OFDMA) for purposes of illustration, other encoding/decoding techniques may be used. That is, this disclosure can be extended to other OFDM-based transmission waveforms or multiple access schemes such as filtered OFDM (F-OFDM). In addition, the principles of this disclosure are equally applicable to different encoding and modulation methods altogether. Examples include LDPC, QPSK, BPSK, QAM, and others.

This present disclosure covers several components which can be used in conjunction or in combination with one another, or which can operate as standalone schemes. Given the sheer volume of terms and vernacular used in conveying concepts relevant to wireless communications, practitioners in the art have formulated numerous acronyms to refer to common elements, components, and processes. For the reader's convenience, a non-exhaustive list of example acronyms is set forth below. As will be apparent in the text that follows, a number of these acronyms below and in the remainder of the document may be newly created by the inventor, while others may currently be familiar. For example, certain acronyms (e.g., CLTM, etc.) may be formulated by the inventors and designed to assist in providing an efficient description of the unique features within the disclosure. A list of both common and unique acronyms follows.

The following documents are hereby incorporated by reference in their entirety into the present disclosure as if fully set forth herein: i) 3GPP TS 38.300 v17.6.0; ii) 3GPP TS 38.331 v17.6.0; and iii) 3GPP TS 38.321 v17.6.0.

3GPP (Third-Generation Partnership Project) has developed technical specifications and standards to define the new 5G radio-access technology, known as 5G NR (new radio). In Release 17 specifications, the non-terrestrial network (NTN) was introduced as a vertical functionality by 5G NR. An NTN provides non-terrestrial NR access to a user equipment (UE) by means of, for example and without limitation, an NTN payload (e.g., a satellite) and an NTN Gateway. The NTN payload can receive the radio protocol received from the UE via a service link (e.g., wireless link between the UE and the NTN payload) and transparently forward it to the NTN Gateway via a feeder link (e.g., wireless link between the NTN payload and the NTN Gateway), and vice versa. Given its capabilities of providing wide coverage and reliable service, the NTN is envisioned to ensure service availability and continuity ubiquitously. For instance, the NTN can support communication services in unserved areas that are not covered by conventional terrestrial networks, as well as in underserved areas with limited communication services. Additionally, the NTN can support communication services for devices and passengers aboard moving platforms, such as future railway, maritime, or aeronautical communication systems. To support the NTN in 5G NR, various features need to be introduced or enhanced to accommodate the nature of radio access to the NTN, which differs from terrestrial network (TN) in aspects, such as large cell coverage, long propagation delay, and non-static cell/satellite.

In the NTN, the NTN payload may be a geosynchronous orbit (GSO) that is an earth-centered orbit at approximately 35,786 kilometers above earth's surface and synchronized with earth's rotation. In addition, the NTN payload may be a non-geosynchronous orbit (NGSO) that is a Low Earth Orbit (LEO) at an altitude approximately between 300 km and 1,500 km or Medium Earth Orbit (MEO) at altitude approximately between 7,000 km and 25,000 km. Depending on different NTN payloads, three types of service links are supported. The first is an earth-fixed service link, provisioned by beams that continuously cover the same geographic areas, such as a GSO satellite. The second is a quasi-earth-fixed service link, provisioned by beams that cover one geographic area for a limited period and another geographic area at a different time, such as an NGSO satellite. The third is an earth-moving service link, provisioned by beams whose coverage area slides over the earth's surface, such as NGSO satellite generating fixed or non-steerable beams.

A base station (BS), operating with the NGSO satellite, can provide either quasi-earth-fixed cell coverage or earth-moving cell coverage, while a BS, operating with the GSO satellite, can provide earth-fixed cell coverage. Due to different properties of GSO and NGSO, different types of cells can be supported in the NTN including, for example, the earth-fixed cell, the quasi-earth-fixed cell, and the earth-moving cell. For a certain type of NTN payload or cell, the UE needs to support specific features or functionalities for radio access to the NTN.

For a UE in connected state (e.g., RRC_CONNECTED), the network may provide measurement configuration for a measurement object, such as intra-frequency neighbor cell or inter-frequency neighbor cell. Based on the UE's measurement result, the BS can prepare a handover (HO) from the current serving cell (or source cell) to a target cell and trigger the handover execution by transmitting a handover command in an RRC message, such as an RRCReconfiguration message. The BS can also prepare a conditional handover (CHO) with one or more candidate cells for the UE and transmit CHO configuration in an RRC message, such as an RRCReconfiguration message, to trigger the CHO evaluation.

Due to the large propagation distance between the UE and gNB (gNodeB, or BS) in the NTN, the handover delay and interruption caused by message exchanges between the UE and gNB can be significant. Additionally, due to the large size of the NTN cell, a large number of UEs may need to perform handover almost simultaneously in a quasi-fixed cell. To reduce handover delay and overhead, random access channel (RACH)-less handover may be preferred. Similarly, for the TN, RACH-less handover can also be implemented to decrease handover delay and overhead.

In the RACH-less handover, when switching to the target cell, UE starts to monitor Physical Downlink Control Channel (PDCCH) on a selected bandwidth part (BWP) using a beam quasi-colocated with the SSB (System Synchronization and PBCH Block) selected for Message 1 (Msg 1) or Message A (Msg A) transmission. For the RACH-less handover, since there is no preamble transmission, an SSB index for PDCCH monitoring for dynamic grant (DG) is directly indicated by the network in the RACH-less handover command. However, if a configured grant (CG) is provided for the initial UL transmission, it is not clear how the UE monitors the PDCCH to confirm the RACH-less handover success.

Additionally, in the CHO or measurement reporting, when a serving cell or a candidate cell is an earth moving cell, UE has to estimate the real-time reference location (moving reference location) of the cell (e.g., serving cell and neighbor cell). However, conventional wireless systems do not provide a mechanism for signaling relevant information related to the CHO or the measurement reporting with the earth-moving cell.

The present disclosure provides a mechanism related to UE behavior on PDCCH monitoring in the RACH-less handover. Additionally, the disclosure provides a mechanism related to estimation of real-time reference location of an earth-moving cell in CHO and measurement reporting.

For the RACH-less handover, the HO command may be conveyed in an RRC message (e.g., RRCReconfiguration message), which includes a configured grant (CG) for the initial UL transmission to the target cell. The CG may be configured so that each CG occasion is mapped to a subset of SSBs. If at least one SSB associated with a CG occasion is above a Reference Signal Received Power (RSRP) threshold, the SSB is selected for the initial UL transmission carried by, for example, PUSCH including an RRCReconfigurationComplete message. UE may indicate the selected SSB to the lower layer (e.g., PHY) and consider the CG valid. In some embodiments, after sending the initial UL transmission, UE starts to monitor PDCCH of the target cell to receive a configuration of the HO completion. UE may monitor PDCCH using the selected SSB. In an embodiment, UE monitors PDCCH using a beam, a reference signal or a TCI (Transmission Configuration Indicator) state. In another embodiment, UE may monitor PDCCH which is quasi-colocated with the selected SSB for the initial UL transmission.

In some embodiments, a beam indication can be configured in the HO command. If the beam indication is included or configured in the HO command, UE may begin monitoring PDCCH of a target cell based on the beam indication when initiating RACH-less HO execution. In an embodiment, the beam indication may be included or indicated in one or more SSBs or in one or more TCI states. In some implementation, an SSB index or TCI state information configured in the HO command indicates a beam that UE uses to monitor PDCCH of the target cell. The beam indication can be informed to a lower layer (e.g., PHY) for PDCCH monitoring. In an implementation, the SSB may be selected for the initial UL transmission carried by, for example, PUSCH including an RRCReconfigurationComplete message.

In some implementations, when a CG for the initial UL transmission to the target cell is configured, UE performs an initial UL transmission for RACH-less handover. Then, UE start to monitor the PDCCH using a selected SSB for the initial UL transmission. When a beam indication is configured in an HO command within an RRC message, UE monitors PDDCH on the beam indication. If a TCI state information indicating a beam for PDCCH monitoring is configured in the HO command, UE informs the TCI state information to a lower layer and starts PDCCH monitoring of the target cell. If an SSB index indicating a beam for PDCCH monitoring is configured in the HO command, UE informs the SSB index to the lower layer and starts PDCCH monitoring of the target cell.

In CHO, a distance event may be configured for CHO execution condition evaluation. In some embodiments, a distance event may be configured in a measurement configuration to trigger measurement report. When a distance between UE and a configured serving cell reference location is larger than a first threshold (Threshold 1) and a distance between UE and a configured neighbor cell (or candidate cell) reference location is smaller than a second threshold (Threshold 2), the distance event is considered met or fulfilled.

When the configured serving cell is an earth-moving cell, the reference location and the associated reference time can be configured in the distance event. When the neighbor cell (or candidate cell) is an earth-moving cell, the corresponding reference location and the associated reference time can be configured in the distance event. In an embodiment, the reference location and the associated reference time for the serving cell may be different from reference location and the reference time (e.g., epoch time) for the serving cell, which are broadcast in a SIB. In another embodiment, the reference location and the associated reference time for the serving cell may be the same as the reference location and the reference time (e.g., epoch time) for the serving cell, which are broadcast in the SIB. In some embodiments, the reference time may be, for example and without limitation, the epoch time for the corresponding cell.

UE may use the reference location, the associated reference time, and the ephemeris associated with the cell (i.e., serving cell and/or neighbor cell) to determine a real-time reference location. In some embodiments, the reference location, the associated reference time, and the ephemeris associated with the serving cell and the neighbor cell can be broadcast in a SIB or signaled dedicatedly to UE. The reference location, the associated reference time, and the ephemeris may be included in the event (e.g., condEventD1 or EvnetD1) or in the measurement object configuration.

For the distance event for an earth-moving cell, if ephemeris for the serving cell and neighbor cell (or candidate cell) is configured and a reference time is configured associated with the reference location, UE may determine, calculate, or derive the instant and real-time reference location (moving reference location) based on the reference time, the configured reference location associated with the reference time, and the ephemeris associated with the cell (serving cell or neighbor cell). In an implementation, the instant and real-time reference location (moving reference location) for serving cell may be determined based on an epoch time, a configured reference location, and ephemeris for the serving cell which are broadcast in SIB. Furthermore, the instant and real-time reference location (moving reference location) for the neighbor cell may be determined based on an epoch time, a configured reference location, and ephemeris for the neighbor cell which are included in the measurement object configuration.

In some embodiments, for the distance event for the earth-moving cell, UE may consider an entering condition for the distance event to be satisfied when both conditions D1-1 and condition D1-2, as specified below, are fulfilled. Additionally, UE may consider a leaving condition for the distance event to be satisfied when conditions D1-3 or condition D1-4, specifically at least one of the two conditions, as specified below, are fulfilled.

### Condition D1-1 (Entering Condition 1)

$$Ml 1 - Hys > Thresh 1$$

### Condition D1-2 (Entering Condition 2)

$$Ml 2 + Hys < Thresh 2$$

### Condition D1-3 (Leaving Condition 1)

$$Ml 1 + Hys < Thresh 1$$

### Condition D1-4 (Leaving Condition 2)

$$Ml 2 - Hys > Thresh 2$$

The variables in the conditions are defined as follows:
Ml1 is the distance between UE and a serving cell instant/real-time reference location for this distance event. For example, referenceLocation1 as defined within reportConfigNR for this event without considering any offsets. The referenceLocation1 is associated with the serving cell.
Ml2 is the distance between UE and a candidate/neighbor cell instant/real-time reference location for this distance event. For example, referenceLocation2 as defined within reportConfigNR for this event without considering any offsets. The referenceLocation2 is associated with the neighbor cell (or candidate cell).
Hys is the hysteresis parameter for this event. For example, hysteresisLocation as defined within reportConfigNR for this event.
Thresh1 is the threshold for this distance event defined as a distance. For example, Thresh1 may be configured with parameter distance ThreshFromReference1, from a reference location configured with parameter referenceLocation1 within reportConfigNR for this distance event
Thresh2 is the threshold for the distance event defined as a distance. For example, Thresh2 may be configured with parameter distance ThreshFromReference2, from a reference location configured with parameter referenceLocation2 within reportConfigNR for this distance event
Ml1 is expressed in meters.
Ml2 is expressed in the same unit as Ml1
Hys is expressed in the same unit as Ml1
Thresh1 is expressed in the same unit as Ml1
Thresh2 is expressed in the same unit as Ml1

In some embodiments, the reference time for the reference location and the assistance information (e.g., ephemeris and/or common TA) of an earth-moving cell (e.g., serving cell and/or neighbor/candidate cell) in a CHO configuration or a measurement object configuration may be indicated by an absolute time in an RRC message that is dedicated to a UE. The RRC message may include a measurement object configuration associated with the earth-moving cell or the report event configuration (e.g., eventD1 or condEventD1) associated with the earth-moving cell. In an NTN cell, the indicated time is referenced at the uplink time synchronization reference point (RP). In an embodiment, the UE may consider the propagation delay between UE and RP when determining the UTC (Coordinated Universal Time) at UE. The UE may count the number of UTC seconds in 10 ms units since 00:00:00 on Gregorian calendar date, Jan. 1, 1900 (midnight between Sunday, Dec. 31, 1899 and Monday, Jan. 1, 1900).

In some embodiments, the epoch time information element (IE) (or IE epoch time) in an RRC message can be reused as the reference time for the reference location and the assistance information (e.g., ephemeris or common TA) of an earth-moving cell (e.g., serving cell and the neighbor/candidate cell) in a CHO configuration or a measurement object configuration. For the neighbor cell, the IE epoch time may be included in the measurement object configuration associated with the earth-moving cell, or in the report event configuration associated with the earth-moving cell. In an embodiment, the epoch time may be the starting time of a downlink (DL) subframe which is indicated by a system frame number (SFN) or a subframe number. The IE epoch time may be mandatory present when NTN-Config is provided in a dedicated configuration. The epoch time may be based on the timing of the serving cell. For example, the SFN and subframe number indicated in the IE epoch time refers to the SFN and subframe number of the serving cell. The RP for the epoch time may be the uplink time synchronization RP of the serving cell. When the IE epoch time is included in NTN-config in a dedicated serving cell configuration (e.g., servingCellConfigComm) for a handover or a conditional handover, the epoch time may be based on the timing of the target cell. For example, the SFN and subframe number indicated in the epoch time may refer to the SFN and subframe number of the target cell, and the RP of the epoch time may be the uplink time synchronization RP of the target cell. For the target cell, UE may consider epoch time, indicated by the SEN and subframe number in this parameter, based on the frame closest to the frame in which the message indicating the epoch time is received.

In some embodiments, a new IE reference time can be introduced for the reference location and the assistance information (e.g., ephemeris and/or common TA) of an earth-moving cell (e.g., serving cell or candidate/neighbor cell) in the CHO configuration or in the measurement object configuration. The IE reference time may be indicated by an SFN or a subframe number. For the candidate/neighbor cell, the IE reference time may be included in the measurement object configuration associated with the earth-moving cell, or in the report event configuration associated with the earth-moving cell. In an embodiment, the reference time may be the starting time of a DL subframe which is indicated by an SFN or a subframe number. The IE reference time may be mandatory present when NTN-config is provided in a dedicated configuration. The IE reference time may be based on the timing of the service cell. For example, the SFN and the subframe number indicated in this parameter refer to the SFN and subframe number of the serving cell. The RP of this reference time may be the uplink time synchronization RP of the serving cell.

In some embodiments, the reference time (e.g., epoch time) in the measurement object configuration associated with an earth-moving cell or in the report event configuration (e.g., eventD1, eventD2, condEventD1, and condEventD2) associated with the earth-moving cell in a dedicated RRC message (e.g., RRCReconfiguration message) to UE may be conditionally configured. In an embodiment, the reference time may be mandatorily present if a conditional event (e.g., condEventD1 or condEventD2) is configured for an earth-moving cell (e.g., serving cell or neighbor/candidate cell) for CHO. The reference time may be associated with the reference location included in the conditional event for the corresponding cell, which is indicated by the PCI (physical cell identifier) in the conditional reconfiguration. When the ephemeris of the same cell is also provided in the measurement object configuration associated with the earth-moving cell or in the report event configuration (e.g., event D1, eventD2, condEventD1, or condEventD2) associated with the earth-moving cell within a dedicated RRC message (e.g., RRC reconfiguration message) transmitted to UE, the reference time is also applied for the earth ephemeris. Otherwise, UE may apply the ephemeris and the corresponding epoch time in the system information (e.g., SIB). For example, the ephemeris of the same cell is not provided in the measurement object configuration associated with the earth-moving cell or in the report event configuration (e.g., event D1, eventD2, condEventD1, or condEventD2) associated with the earth-moving cell within a dedicated RRC message (e.g., RRCReconfiguration message) transmitted to UE, UE may apply the ephemeris and the corresponding epoch time broadcast in SIB.

In some embodiments, the IE epoch time can be reused as the reference time for the reference location or the assistance information (e.g., ephemeris or common TA) of an earth-moving cell (e.g., serving cell and candidate cell) in a CHO configuration or in a measurement object configuration. For the candidate cell which is an earth-moving cell, the epoch time and the assistance information may be broadcast in SIB 19. In an embodiment, when the epoch time broadcast in SIB 19 can be used to evaluate the CHO execution condition (e.g., condEventD1) for the handover or the conditional handover, the IE epoch time may be based on the timing of the serving cell. In an implementation, the SFN or the subframe number indicated in the IE epoch time refers to the SFN and the subframe number of the serving cell. The RP for epoch time is the uplink time synchronization RP of the serving cell. When the IE epoch time is included in NTN-config in a dedicated serving cell configuration (e.g., servingCellConfigCommon) for the handover or the conditional handover, the IE epoch time may be based on the timing of the target cell. In an implementation, the SFN and the subframe number indicated in the IE refers to the SFN and the subframe number of the target cell. The RP for the epoch time is the uplink time synchronization RP of the target cell. For the target cell, the UE may consider the epoch time, indicated by the SEN and the subframe number in the field, based on the frame closest to the frame in which the message indicating the epoch time is received.

In some embodiments, t-Service parameter indicates the time information on when a cell provided via NTN quasi-earth fixed system is going to stop serving the area it is currently covering. The parameter applies for both the service link switch in NTN quasi-earth fixed system and the feeder link switch for both NTN quasi-earth fixed system and earth-moving system. The parameter indicates a time in multiples of 10 ms after 00:00:00 on Gregorian calendar date Jan. 1, 1900 (midnight between Sunday, Dec. 31, 1899, and Monday, Jan. 1, 1900). The indicated time is referenced at the uplink time synchronization reference point. In an embodiment, UE may consider the propagation delay between UE and RP when determining the UTC time at the UE. The exact stop time may be between the time indicated by the value of the field minus 1 and the time indicated by the value of this parameter. In some embodiments, UE may receive the t-service parameter included in an RRC IE, such as SIB 19. UE may initiate satellite switch with resynchronization based on a time indicated by the t-service parameter broadcasted in SIB 19.

In some embodiments, the validity duration of the reference location or the assistance information (e.g., ephemeris or common TA) of an earth-moving cell (e.g., serving cell and candidate cell) may be included in the measurement object configuration associated with the earth-moving cell or in the report event configuration (e.g., eventD1 or condEventD1) associated with the earth-moving cell. If the validity duration is present, UE may start a timer from the start time and set a timer length according to the validity duration. The start time may be indicated by the reference time (or epoch time). UE may stop measuring the object configured with the validity duration when the timer expires or is not running. If the validity duration is absent, the UE considers the reference location or the assistance information (e.g., ephemeris and/or common TA) associated with the earth-moving cell to be valid.

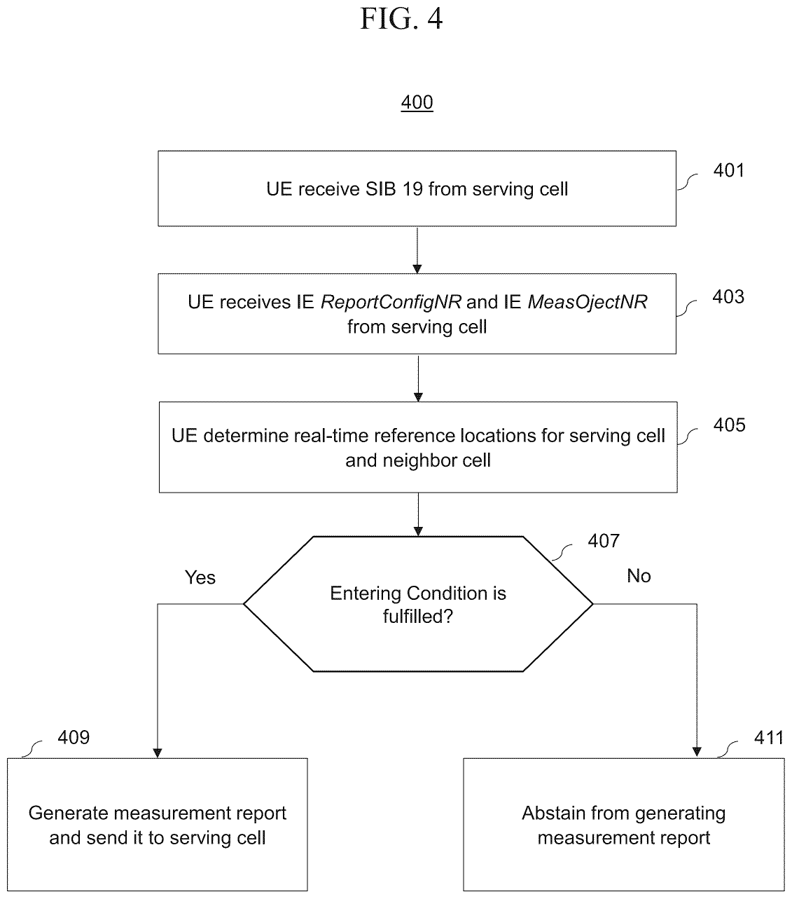

FIG. 4 shows an example process 400 for measurement reporting in accordance with an embodiment. For explanatory and illustration purposes, the example process 400 may be performed by an UE. Although one or more operations are described or shown in particular sequential order, in other embodiments the operations may be rearranged in a different order, which may include performance of multiple operations in at least partially overlapping time periods.

Referring to FIG. 4, the process 400 may begin in operation 401. In operation 401, UE receives a system information block (e.g., SIB 19) from a serving cell. The system information block may include a reference location to the serving cell, ephemeris information associated with the serving cell, and reference time (e.g., epoch time) associated with the serving cell.

In operation 403, UE receives a report configuration (e.g., an RRC IE ReportConfigNR) and a measurement object configuration (e.g., IE MeasOjectNR) from the serving cell. The serving cell is an earth-moving cell. The report configuration (e.g., IE ReportConfigNR) may provide specific conditions to trigger measurement reporting. In some embodiments, the IE ReportConfigNR may include information (e.g., thresholds) for a distance event triggering the measurement reporting. The measurement object configuration (e.g., IE MeasOjectNR) may include a reference location to a neighbor cell, ephemeris information associated with the neighbor cell, and reference time (e.g., epoch time) associated with the neighbor cell. The neighbor cell is an earth-moving cell.

In operation 405, UE determines a real-time reference location (or moving reference location) for the serving cell based on the reference location, the ephemeris information, and the epoch time broadcast in the system information block. Additionally, UE determines a real-time reference location (or moving reference location) for the neighbor cell based on the reference location, ephemeris information, and the epoch time received from the measurement object configuration.

In operation 407, UE determines whether an entering condition for the measurement reporting event is satisfied. More specifically, UE determines that the entering condition is satisfied when i) a distance between UE and the real-time reference location for the serving cell is above a first threshold and ii) a distance between UE and the real-time reference location for the neighbor cell is below a second threshold. The real-time reference locations for the serving cell and the neighbor cell are determined in operation 405. The first threshold and the second threshold are provided IE ReportConfigNR in operation 403. In another embodiment, UE determines that the entering condition is satisfied when both Condition D1-1 (described above) and Condition D1-2 (described above) are fulfilled. When the entering condition for the measurement reporting event is satisfied, the process 400 proceeds to operation 409. Otherwise, it proceeds to operation 411.

In some embodiments, UE may also determine whether a leaving condition for the measurement reporting event is satisfied. More specifically, UE determines that the leaving condition is satisfied when i) a distance between UE and the real-time reference location for the serving cell is below the first threshold or ii) a distance between UE and the real-time reference location for the neighbor cell is above the second threshold. In another embodiment, UE determines that the leaving condition is satisfied when at least one of Condition D1-3 (described above) or Condition D1-4 (described above) are fulfilled. When the leaving condition for the measurement reporting event is satisfied, the process 400 proceeds to operation 413.

In operation 411, UE generates a measurement report and sends it to the serving cell. In operation 413, UE abstains from generating the measurement report.

Various embodiments in the disclosure provides a mechanism to estimate the real-time reference location for the serving cell and the neighbor cell if the serving cell and/or the neighbor cell are earth-moving cell in CHO or in measurement report event.

Various embodiments in the disclosure provide a UE behavior on PDCCH monitoring in RACH-less handover or conditional handover.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the disclosure. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems may generally be integrated together in a single software/hardware product or packaged into multiple software/hardware products.

The disclosure is provided to enable any person skilled in the art to practice the various aspects described herein. In some instances, well-known structures and components are shown in block diagram form to avoid obscuring the concepts of the subject technology. The disclosure provides myriad examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, the detailed description provides illustrative examples, and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A user equipment (UE) for facilitating communication in a wireless network, the UE comprising:
a processor configured to:
determine whether an entering condition is satisfied, wherein the entering condition is whether i) a first distance between the UE and a serving cell moving reference location is above a first threshold and ii) a second distance between the UE and a neighbor cell moving reference location is below a second threshold; and
generate a measurement report based on a determination that the entering condition is satisfied; and
a transceiver operably coupled to the processor, the transceiver configured to:
transmit, to a serving cell, the measurement report.

2. The UE of claim 1, wherein the processor is further configured to:
determine whether a leaving condition is satisfied, wherein the leaving condition is whether i) the first distance between the UE and the serving cell moving reference location is below the first threshold or ii) the second distance between the UE and the neighbor cell moving reference location is above the second threshold.

3. The UE of claim 1, wherein:
the transceiver is further configured to receive, from the serving cell, a system information block that includes a first reference location, a first ephemeris information, and a first epoch time for the serving cell; and
the processor is further configured to determine the serving cell moving reference location based on the first reference location, the first ephemeris information, and the first epoch time.

4. The UE of claim 1, wherein:
the transceiver is further configured to receive, from the serving cell, a measurement object configuration that includes a second reference location, a second ephemeris information, and a second epoch time for a neighbor cell; and
the processor is further configured to determine the neighbor cell moving reference location based on the second reference location, the second ephemeris information, and the second epoch time.

5. The UE of claim 1, wherein the processor is configured to determine that the entering condition is satisfied when a first entering condition and a second entering condition are fulfilled,
wherein the first entering condition:
$$Ml 1 - Hys > Thresh 1$$
where Ml1 is the first distance, Hys is a hysteresis parameter, and Thresh1 is the first threshold,
wherein the second entering condition:
$$Ml 2 + Hys < Thresh 2$$
where Ml2 is the second distance, Hys is the hysteresis parameter, and Thresh2 is the second threshold.

6. The UE of claim 2, wherein the processor is configured to determine that the leaving condition is satisfied when at least one of a first leaving condition or a second leaving condition is fulfilled,
wherein the first leaving condition:
$$Ml 1 + Hys < Thresh 1$$
where Ml1 is the first distance, Hys is a hysteresis parameter, and Thresh1 is the first threshold,
wherein the second leaving condition:
$$Ml 2 - Hys > Thresh 2$$
where Ml2 is the second distance, Hys is the hysteresis parameter, and Thresh2 is the second threshold.

7. The UE of claim 4, wherein the measurement object configuration is configured by the serving cell for the neighbor cell served by a non-terrestrial network earth moving cell.

8. The UE of claim 1, wherein the transceiver is further configured to receive, from the serving cell, a configuration that indicates the first threshold and the second threshold.

9. A base station (BS) for facilitating communication in a wireless network, the BS comprising:
a processor configured to:
generate a configuration that triggers a measurement reporting event, the configuration indicating a first threshold and a second threshold that are associated with an entering condition for the measurement reporting event, wherein the entering condition is whether i) a first distance between a user equipment (UE) and a serving cell moving reference location is above the first threshold and ii) a second distance between the UE and a neighbor cell moving reference location is below the second threshold; and
a transceiver operably coupled to the processor, the transceiver configured to:
transmit, to the UE, the configuration.

10. The BS of claim 9, wherein:
the first threshold and the second threshold are associated with a leaving condition for the measurement reporting event; and
the leaving condition is whether i) the first distance between the UE and the serving cell moving reference location is below the first threshold and ii) the second distance between the UE and the neighbor cell moving reference location is above the second threshold.

11. The BS of claim 9, wherein:
the processor is further configured to generate a system information block that includes a first reference location, a first ephemeris information, and a first epoch time for a serving cell associated with the base station; and
the transceiver is further configured to transmit, to the UE, the system information block,
wherein the serving cell moving reference location is determined based on the first reference location, the first ephemeris information, and the first epoch time.

12. The BS of claim 9, wherein:
the processor is further configured to generate a measurement object configuration that includes a second reference location, a second ephemeris information, and a second epoch time for a neighbor cell; and
the transceiver is further configured to transmit, to the UE, the measurement object configuration,
wherein the neighbor cell moving reference location is determined based on the second reference location, the second ephemeris information, and the second epoch time.

13. A method performed by a user equipment (UE) for facilitating communication in a wireless network, comprising:
determining whether an entering condition is satisfied, wherein the entering condition is whether i) a first distance between the UE and a serving cell moving reference location is above a first threshold and ii) a second distance between the UE and a neighbor cell moving reference location is below a second threshold;
generating a measurement report based on a determination that the entering condition is satisfied; and
transmitting, to a serving cell, the measurement report.

14. The method of claim 13, further comprising:
determining whether a leaving condition is satisfied, wherein the leaving condition is whether i) the first distance between the UE and the serving cell moving reference location is below the first threshold or ii) the second distance between the UE and the neighbor cell moving reference location is above the second threshold.

15. The method of claim 13, further comprising:
receiving, from the serving cell, a system information block that includes a first reference location, a first ephemeris information, and a first epoch time for the serving cell; and
determining the serving cell moving reference location based on the first reference location, the first ephemeris information, and the first epoch time.

16. The method of claim 13, further comprising:
receiving, from the serving cell, a measurement object configuration that includes a second reference location, a second ephemeris information, and a second epoch time for a neighbor cell; and
determining the neighbor cell moving reference location based on the second reference location, the second ephemeris information, and the second epoch time.

17. The method of claim 13, wherein the entering condition is satisfied when a first entering condition and a second entering condition are fulfilled,
wherein the first entering condition:
$$Ml 1 - Hys > Thresh 1$$
where Ml1 is the first distance, Hys is a hysteresis parameter, and Thresh1 is the first threshold,
wherein the second entering condition:
$$Ml 2 + Hys < Thresh 2$$
where Ml2 is the second distance, Hys is the hysteresis parameter, and Thresh2 is the second threshold.

18. The method of claim 14, wherein the leaving condition is satisfied when at least one of a first leaving condition or a second leaving condition is fulfilled,
wherein the first leaving condition:
$$Ml 1 + Hys < Thresh 1$$
where Ml1 is the first distance, Hys is a hysteresis parameter, and Thresh1 is the first threshold,
wherein the second leaving condition:
$$Ml 2 - Hys > Thresh 2$$
where Ml2 is the second distance, Hys is the hysteresis parameter, and Thresh2 is the second threshold.

19. The method of claim 16, wherein the measurement object configuration is configured by the serving cell for the neighbor cell served by a non-terrestrial network earth moving cell.

20. The method of claim 13, further comprising:
receiving, from the serving cell, a configuration that indicates the first threshold and the second threshold.
